(19) United States
(12) Patent Application Publication
(10) Pub. No.: US 2004/0184193 A1
(43) Pub. Date: Sep. 23, 2004

(54) Magnetic head apparatus, magnetic head supporting mechanism and magnetic recording apparatus

(75) Inventors: Takashi Honda, Tokyo (JP); Takeshi Wada, Tokyo (JP); Yoshihisa Higuchi, Tokyo (JP); Katsuki Kurihara, Tokyo (JP); Hideki Kuwajima, Kyoto-shi (JP); Kaoru Matsuoka, Osaka-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: TDK CORPORATION, Tokyo (JP); MATSUSHITA ELECTRIC INDUSTRIAL, Kadoma-shi (JP)

(21) Appl. No.: 10/626,603

(22) Filed: Jul. 25, 2003

(30) Foreign Application Priority Data
Jul. 25, 2002 (JP) 2002-216652

(51) Int. Cl. G11B 5/48

(52) U.S. Cl. 360/244.2

(57) ABSTRACT

A load beam is provided with a base plate and a slider. A magnetic head apparatus is fixed to a head arm via the base plate. In such a magnetic head supporting mechanism, an elastically deformable portion is provided between the base plate and the load beam. Thus a floating structure that allows the load beam to swing is formed about the elastically deformable portion. A projection bulging from the load beam serving as a load generating portion is adapted to coincide with a balanced fulcrum about the load beam, and a pressing load of the slider to a recording medium is set by a pressure applied to the top of the projection.

### BACKGROUND OF THE INVENTION

1. Field of the Invention

The present invention relates to a magnetic head apparatus, magnetic head supporting mechanism and a magnetic recording apparatus. Specifically, the present invention relates to a magnetic head apparatus, magnetic head supporting mechanism and a magnetic recording apparatus that have improved impact resistance.

2. Related Background Art

FIG. 32 is a drawing schematically illustrating the outline of a prior art magnetic recording apparatus. The magnetic recording apparatus 101 shown in FIG. 32 is provided with a magnetic disk 102 serving as a rotatable recording medium and a magnetic head supporting mechanism 104 for moving a magnetic head 103 flying above the magnetic disk 102 in a radial direction of the magnetic disk 102. In the magnetic recording apparatus 101 having the above-described structure, a servo signal (i.e. position information) that has been written in the surface of the magnetic disk 102 in advance is read by the magnetic head 103, and electric power is supplied to a movable coil 105 provided at the opposite end of the magnetic head 103 in accordance with the read information, so that a force is generated in a magnetic circuit 106 in the directions indicated by an arrow 107. Thus, the magnetic head 103 is moved to a target track (or a target position).

FIG. 33 is a drawing schematically showing how the magnetic head apparatus is disposed in relation to the magnetic disk. As shown in this drawing, a load beam 108 is provided at the intermediate portion of the magnetic head 103. One end portion of the load beam 108 is secured to a base plate 109 that makes a junction with the magnetic head supporting mechanism 104. On the other end portion of the load beam 108, there is provided a slider 110 secured thereto. In addition, a leaf spring portion is provided at the boundary 111 of the load beam 108 and the base plate 109. A pressing load (i.e. so-called load pressure) of the slider 110 against the magnetic disk 102 is adapted to be provided by an urging force generated by this leaf spring portion.

However, the above-described magnetic recording apparatus suffers from the following problem. The mounting structure of the conventional magnetic head apparatus is a cantilever structure with the base plate 109 being the pivot. Therefore, if for example an impact is applied to it in the vertical direction (i.e. the thickness direction of the magnetic disk 102), a rotation moment (or torque) about the base plate 109 is generated with the slider 110 being a mass point. When a force created by the rotation moment exceeds the pressing load for the slider 110, the slider 110 would be detached from the surface of the magnetic disk 102 for a moment and then hit the surface of the magnetic disk 102. This can damage the slider 110 itself or make a flaw on the surface of the magnetic disk 102 to deteriorate data that have already been written.

On the other hand, the apparatus is so adapted that the pressing load for the slider 110 about the base plate 109 is generated by the leaf spring portion formed at the root side end of the load beam 108 (i.e. at the boundary with the base plate 109). Therefore, it is necessary to form two different portions (i.e. the leaf spring portion and a rigid body portion) having different properties in the load beam 108, namely, the structure of the load beam 108 is complex. This is another problem. In addition, forming of the leaf spring portion requires high precision bending processing on the load beam and inspection after the processing, which increase the number of the manufacturing processes. This is also a problem.

Various technologies for eliminating the above-mentioned problems have been proposed. For example, Japanese Patent Application Laid-Open No. 9-82052 discloses a structure provided with a second load beam that extends from a load beam attached with a slider at the opposite end thereof and a loading member provided on the second load beam so that the center of the acceleration caused by an impact would coincide with the center of rotation of the slider.

Another document Japanese Patent Application Laid-Open No. 8-102159 discloses a structure in which a free end portion of a suspension can be in contact with a pin-like projection provided on a base or a cover. In addition, Japanese Patent Application Laid-Open No. 2001-57032 discloses a structure provided with a limiter that is formed as an extension from a part of a base portion for mounting a suspension to limit a movable range of the load beam so as to prevent a damage caused by an impact. The suspension disclosed in Japanese Patent Application Laid-Open No. 8-102159 is adapted to function in a similar manner as the above-described load beam, and so it can bias a magnetic head provided at its free end against a surface of a magnetic disk.

However, in the structure disclosed in Japanese Patent Application Laid-Open No. 9-82052, the load applied to the slider is given by a bias created by a spring provided on the load beam. Therefore, high precision bending processing is required to be made on the load beam. In addition, since a spring mechanism is present in the intermediate portion of the mechanism, it is difficult to prevent flipping due to a rotation moment generated by an acceleration applied to the load beam. On the other hand, the structure disclosed in Japanese Patent Application Laid-Open No. 8-102159 provides a countermeasure only against an impact applied under the state in which the magnetic head apparatus is in a shipping zone (i.e. the state in which the magnetic disk is out of operation), but it does not provide any countermeasure against an impact applied under the state in which the magnetic head apparatus is in the data zone (i.e. the state in which the magnetic disk is under operation). In addition, in the structure disclosed in Japanese Patent Application Laid-open No. 2001-57032, in spite of the provision of the limiter for limiting the movable range of the load beam, the load applied to the slider is given by a bias created by a spring provided on the load beam. Therefore, high precision bending processing is required to be made on the load beam, as is the case with the structure disclosed in Japanese Patent Application Laid-Open No. 9-82052.

### SUMMARY OF THE INVENTION

The present invention has been made in view of the above-described problems. An object of the present invention is to enhance impact resistance of a magnetic recording apparatus during both operating state and non-operating (or resting) state and to provide a magnetic head apparatus, a magnetic head supporting mechanism and a magnetic recording apparatus in which a pressing load against a recording medium can be set easily and with high precision.

The magnetic head apparatus, the magnetic head supporting mechanism and the magnetic recording apparatus according to the present invention have been developed based on such a concept that if a load beam as a whole is regarded as one rigid body, a spring structure is provided between the load beam and a mounting member and a balance structure is constructed by supporting the center of mass of the load beam as a balanced fulcrum, then the load beam would not rotate about the balanced fulcrum even if an impact is applied in the vertical direction, which, in combination with reduction of the weight suspended by the spring, contributes to enhancement of impact resistance.

A magnetic head apparatus according to the present invention comprises a load beam to which a slider is attached, an elastically deformable portion that is provided on the load beam so that a floating structure that allows the load beam to swing is formed about the elastically deformable portion, and a projection bulging from the load beam that is adapted to function as a load generating portion, wherein a pressing load of the slider against a recording medium is set by a pressure applied to a top portion of the projection.

A magnetic head apparatus according to another mode of the present invention comprises a load beam to which a slider is attached, an elastically deformable portion that is provided on the load beam so that a floating structure that allows the load beam to swing is formed about the elastically deformable portion, and a projection bulging from the load beam that is adapted to function as a load generating portion, wherein the projection is adapted to coincide with a balanced fulcrum about the load beam, and a pressing load of the slider against a recording medium is set by a pressure applied to a top portion of the projection.

According to more specific mode of the present invention, there is provided a magnetic head apparatus comprising a base plate adapted to be attached to a head arm, a load beam that extends from the base plate, a slider attached to the load beam, an elastically deformable portion provided between the base palate and the load beam so that a floating structure that allows the load beam to swing is formed about the elastically deformable portion, and a projection bulging from the load beam that is adapted to function as a load generating portion, wherein the projection is adapted to coincide with a balanced fulcrum about the load beam, a pressing load is applied to a surface of a recording medium via the slider, and the pressing load of the slider against the recording medium is set by a pressure applied to a top portion of the projection.

It is preferable that the above-mentioned projection bulging from the load beam be adapted to set such a limited area around said projection with which when an impact within a predetermined value range is applied to said load beam in a vertical direction, deformation of said load beam would remain within elastic deformation range. In addition, it is preferable that balancing is attained by a dead weight made of a vibration damping material. The dead weight may be made of a resin. The load beam may also be made of a resin. In that case, it is preferable that the resin for the load beam be an electrically conductive resin so that the load beam would be in electrical contact with an external member. Alternatively, the resin may have an electrically conductive coating formed thereon so that the load beam would be in electrical contact with an external member through the electrically conductive coating.

The head arm, which is supported in such a way as to be swingable in a radial direction of the recording medium may be provided with a strengthen plate attached perpendicularly to the head arm in such a way that it does not interfere with the recording medium within the swing range of the head arm.

A magnetic head supporting mechanism according to the present invention comprises a magnetic head apparatus including a base plate and a load beam extending from the base plate, a head arm attached to the base plate, a slider attached to the load beam, an elastically deformable portion provided between the base plate and the load beam, which elastically deformable portion is flexible so that a floating structure that allows the load beam to swing is formed about the elastically deformable portion, and a projection bulging from the load beam that is adapted to function as a load generating portion, wherein a pressing load is applied to a surface of a recording medium via the slider, and the pressing load of the slider against the recording medium is set by a pressure applied to a top portion of the projection.

A magnetic head supporting mechanism according to another mode of the present invention comprises a magnetic head apparatus including a base plate and a load beam extending from the base plate, a head arm attached to the base plate, a slider attached to the load beam, an elastically deformable portion provided between the base plate and the load beam, which elastically deformable portion is flexible so that a floating structure that allows the load beam to swing is formed about the elastically deformable portion, and a projection bulging from the load beam that is adapted to function as a load generating portion, wherein the projection is adapted to coincide with a balanced fulcrum about the load beam, a pressing load is applied to a surface of a recording medium via the slider, and the pressing load of the slider against the recording medium is set by a pressure applied to a top portion of the projection. It is preferable that the above-mentioned projection bulging from the load beam be adapted to set such a limited area around the projection with which when an impact within a predetermined value range is applied to the load beam in a vertical direction, deformation of the load beam would remain within elastic deformation range.

In addition, it is preferable that balancing is attained by a dead weight made of a vibration damping material. The dead weight may be made of a resin. The load beam may also be made of a resin. In that case, it is preferable that the resin for the load beam be an electrically conductive resin so that the load beam would be in electrical contact with an external member. Alternatively, the resin may have an electrically conductive coating formed thereon so that the load beam would be in electrical contact with an external member through the electrically conductive coating

The head arm, which is supported in such a way as to be swingable in a radial direction of the recording medium may be provided with a strengthen plate attached perpendicularly to the head arm in such a way that it does not interfere with the recording medium within the swing range of the head arm.

A magnetic head supporting mechanism according to still another mode of the present invention comprises a support arm swingable in a radial direction of a recording medium and in a direction perpendicular to a recording surface of the recording medium with a bearing portion being a pivot, a head attached to a lower surface of the support arm at one end of the support arm, elastic means provided on the support arm for imparting a biasing force in the direction toward the recording medium to the support arm, and a projection bulging from the support arm adapted to be in point contact with the bearing portion, wherein the support arm is adapted to be swingable in the direction perpendicular to the recording surface with a point at which a top portion of the projection and the bearing portion are in contact with each other being a balanced fulcrum. It is preferable that the projection bulging from the arm sets such a limited area around the projection with which when an impact within a predetermined value range is applied to the support arm in a vertical direction, deformation of a portion in the vicinity of the projection would remain within elastic deformation range.

According to the present invention, there is also provided a magnetic recording apparatus equipped with a magnetic head apparatus or a magnetic head supporting mechanism according to any one of the above-described modes of the present invention.

In the above description, the term “floating structure” refers to a structure in which a load beam and a base plate is not joined by a rigid body, so that an impact applied on the base plate can be prevented from being transmitted to the load beam directly.

According to the above-described structures, the elastically deformable portion is provided on the load beam to which the slider is attached and the weight of the load beam is balanced with respect to the projection bulging from the load beam. (The balancing of the weight may be attained by attaching a dead weight to the load beam at a position opposite to the position at which the slider.) With the above-described structure in which the load beam is supported by a floating structure via an elastically deformable portion in further combination with the structure in which the load beam is swingable about a fulcrum in the form of a projection formed thereon, it is possible to prevent a rotational force about the projection (or the load generating portion) from being created, even if an impact is applied to the load beam. Thus, the slider will not be detached from the recording medium by such a rotational force. Therefore, it is possible to prevent the slider from colliding with the recording medium to damage it or prevent the magnetic head apparatus itself from being damaged by an impact. Furthermore, since the projection serving as a load generating portion bulges from the load beam, the top of the projection is in point contact with an external member. Thus, the pressure applied to the top of the projection will be distributed or deconcentrated on the load beam through a flared portion (i.e. a portion having an enlarged diameter) of the projection. Therefore, a concentrated load will not be applied to a localized area of the load beam, and so deformation of the load beam can be prevented. In the magnetic recording apparatus equipped with the magnetic head apparatus or the magnetic head supporting mechanism according to the present invention, a limit impact value is generally set. When an impact corresponding to the limit value is applied to the load beam via the projection, an impact force will be applied instantaneously to the load beam at the portion around the projection (i.e. at the peripheral portion of the projection). In this case, if the diameter of the projection is enlarged, a limited area in which the impact is received is enlarged, so that a stress created by the impact can be reduced. Thus, it is possible to limit the stress within the range that would cause only elastic deformation of the material that composes the load beam. Therefore, the load beam can maintain stable performance without being deformed. In connection with this, means for reducing stress (in other words, means for enlarging the limited area) is not limited to the enlargement of the peripheral portion of the projection. The reduction of the limited area may be attained by forming multiple projections or by combination of the enlargement and the multiplication of the projections.

The load beam would be rotated or swung about the elastically deformable portion by application of an external pressure to the projection formed on the load beam. Therefore, a pressing load of the slider against the recording medium can be set (or determined) by adjusting the amount of the rotation. Since the pressing load is determined by the rotation amount of the load beam in this way, it is possible to create an accurate pressing load and to suppress variations in the pressing load. In addition, since an elastic bending for providing a pressing load to the load beam need not be formed on the load beam, a high precision bending process for processing the load beam or an inspecting process for measuring a spring load can be omitted. Therefore, it is apparent that the manufacturing process of the apparatus can be made simple.

With the structure in which the load beam is joined to the base plate via the elastically deformable portion, the magnetic head apparatus can be constructed as a floating structure without constructing the whole of the magnetic head supporting mechanism or the whole of an actuator (including a head arm and VCM etc.) as a floating structure. Therefore, the weight or mass of the portion provided below the elastically deformable portion is reduced (i.e. reduction of the mass suspended by a spring). This reduction of the weight would result in enhancement of impact resistance.

Furthermore, with the structure in which an extrusive surface is formed on the head arm, when the extrusive surface and the projection on the load beam are in contact with each other, the load beam is rotated about the elastically deformable portion by an amount corresponding to the height of the projection. Therefore, it is possible to obtain a pressing load without a variation between individual products, by controlling the height of the projection.

The balancing of the weight of the load beam with respect to the projection may be attained by adding a dead weight to the load beam and/or by forming a hole for the purpose of reducing the weight. When the dead weight is attached to the load beam, a vibration damping member such as a vibration suppressing steel plate may preferably be used as the dead weight. In that case, the peak value of the natural resonance frequency (so-called resonance point) of the load beam can be reduced as desired. Therefore, stability of the actuator system can be enhanced.

In the present invention, the load beam can be designed as a structure that is not required to have an elastic portion, and therefore the load beam may be made of various materials. In other words, the material of the load beam is not limited to conventional metal materials such as a stainless steel, but the load beam may be made of a resin. With the use of a load beam made of a resin, it is possible to reduce the weight greatly as compared to conventional load beams made of metal materials. In other words, the weight or mass of the portion provided below the elastically deformable portion is reduced with the use of the load beam made of a resin (i.e. reduction of the mass suspended by the spring). This reduction of the weight would further enhance impact resistance.

If the resin for the load beam is an electrically conductive resin, it is possible to make the electric potentials of the load beam, the actuator and the base side of the magnetic recording apparatus equal to each other. Therefore, it is possible to prevent electrostatic discharge from occurring on the load beam. Thus, damaging of the magnetic head apparatus by static electricity can be prevented. The same effect would also be realized by forming an electrically conductive coating on a resin instead of using an electrically conductive resin. It is preferable that the electrically conductive coating be a metal coating in view of its low volume resistance. It is apparent that the combination of an electrically conductive resin and an electrically conductive coating would realize a more preferable effect.

With the use of the above-described magnetic head apparatus or the actuator in a magnetic recording apparatus, it is possible to enhance impact resistance of the magnetic recording apparatus both in the operating state and in the non-operating state, irrespective of the size of the magnetic recording apparatus. Therefore, reliability of the magnetic recording apparatus can be enhanced.

If a projection(s) is formed in the vicinity of the pivot center of a support arm to which a head and elastic means are attached and the projection(s) is made to be in point contact with a bearing, a balance structure with the projection being the balanced fulcrum will be realized, so that a swing movement of the support arm would not occur even if an impact is applied in the vertical direction. Therefore, impact resistance can be enhanced. Furthermore, with the structure in which the projection is formed on the support arm and the top portion of the projection is adapted to be in point contact with the part of bearing portion, a concentrated load of an impact force is prevented from being applied to the support arm, and therefore deformation of the support arm can be prevented. In addition, with the enlargement of the diameter of the projection bulging from the support arm or with the increase in the number of the projections, the limited area in which the impact is received is enlarged and the stress generated by the impact can be reduced. Thus, it is possible to limit the stress within the range that would cause only elastic deformation of the material that composes the load beam. Therefore, the load beam can maintain stable performance without being deformed.

It should be understood that the term “magnetic head apparatus” refers to an apparatus in the form of a head gimbal assembly (HGA) including a slider and a load beam, while the term “magnetic head supporting mechanism” refers to a structure including the magnetic head apparatus and a head arm (and a base plate). The term “base plate” refers to a portion to be attached to a head arm. The base plate may be formed as a separate member or formed integrally.

Other features and objects of the present invention will become apparent from the following detailed description and the annexed drawings.

### BRIEF DESCRIPTION OF THE DRAWINGS

FIG. 1 is a side view for illustrating the operation principle of a head supporting mechanism according to a first embodiment of the present invention.

FIG. 2 is a plan view for illustrating the operation principle of the head supporting mechanism according to the first embodiment of the present invention.

FIG. 3 is a perspective view showing the structure of a head supporting mechanism according to a second embodiment of the present invention.

FIG. 4 is an exploded perspective view sowing the structure of the head supporting mechanism according to the second embodiment of the present invention.

FIG. 5 is the side view showing a portion around a bearing of the head supporting mechanism according to the second embodiment of the present invention.

FIG. 6 is a plan view showing the structure of a magnetic head apparatus according to a third embodiment of the present invention.

FIG. 7 is a drawing showing how a load beam is swung by a pressing force applied to an extrusive surface.

FIG. 8 is an exploded perspective view showing how the magnetic head apparatus and a head arm are joined in relation to each other.

FIG. 9 is front view showing a magnetic head supporting mechanism formed by mounting the magnetic head apparatus to the head arm.

FIG. 10 is a drawing for illustrating how the magnetic head apparatus according to the third embodiment of the present invention is assembled with a recording medium, which shows a state before the assembling.

FIG. 11 is a drawing for illustrating how the magnetic head apparatus according to the third embodiment is assembled with a recording medium, which shows a state after the assembling.

FIG. 12 is a plan view showing a magnetic recording apparatus equipped with the magnetic head or a magnetic head supporting mechanism according to the third embodiment of the present invention.

FIG. 13 is a cross sectional view taken on line 13-13 in FIG. 12.

FIG. 14 is a schematic drawing for illustrating impact resistance performance of the magnetic head apparatus according to the third embodiment of the present invention.

FIG. 15 is an exploded view showing a modification of the magnetic head supporting structure according to the third embodiment of the present invention.

FIG. 16 is a side view showing an arm assembly to which strengthen plates are attached.

FIG. 17 is a plan view showing the arm assembly to which strengthen plates are attached.

FIG. 18 is a drawing showing an arm assembly including multiple heads to which strengthen plates are attached.

FIG. 19 is a drawing showing an arm assembly including a single head to which a strengthen plate is attached.

FIG. 20 is a side view illustrating a head supporting mechanism.

FIG. 21 is an exploded view showing parts of the head supporting mechanism.

FIG. 22 is an enlarged view showing a portion of FIG. 21.

FIG. 23 is a perspective view showing how a head arm and a load beam are joined.

FIG. 24 is a front view showing a magnetic head apparatus and a head arm that are assembled together.

FIG. 25 is a back view showing the magnetic head apparatus and the head arm that are assembled together.

FIG. 26 is a drawing illustrating a process for forming projections using a press working.

FIG. 27 is a drawing illustrating a process for forming projections by fitting an upper stamp with a lower stamp.

FIG. 28 is a drawing illustrating a process for forming projections by fitting an upper stamp with a lower stamp.

FIG. 29 is a drawing illustrating a process for forming projections by etching.

FIG. 30 is a drawing illustrating a process for forming projections by etching.

FIG. 31 is a drawing illustrating a process for forming projections by etching.

FIG. 32 is a drawing illustrating the outline of a conventional magnetic recording apparatus.

FIG. 33 is a drawing schematically illustrating how a magnetic head apparatus is assembled with a magnetic disk.

### DETAILED DESCRIPTION OF THE PREFERRED EMBODIMENTS

In the following, specific embodiments of a magnetic head apparatus, a magnetic head supporting mechanism and a magnetic recording apparatus according to the present invention will be specifically described with reference to the drawings.

### First Embodiment

First, the operation principle of a head supporting mechanism according to the present invention will be described in connection with an example in the form of a magnetic recording apparatus as a first embodiment.

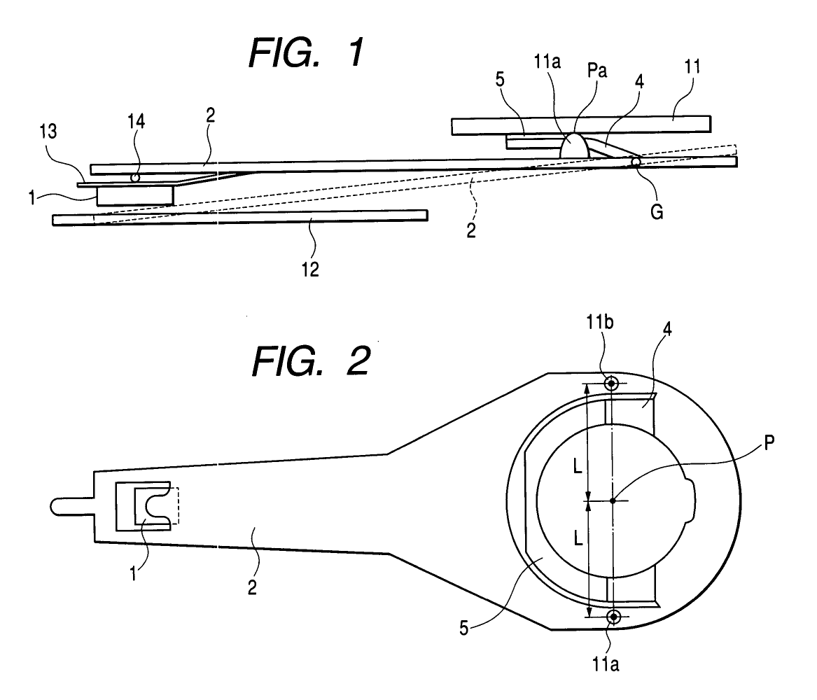

FIG. 1 is a side view schematically showing the overall structure of the head supporting mechanism, which is presented for illustrating the operation principle of the head supporting mechanism according to the present invention. FIG. 2 is a plane view showing the same.

Referring to the structure shown in FIGS. 1 and 2, a supporting arm 2 is equipped with a slider 1 having a magnetic converting element (not shown). The slider 1 is mounted on the lower surface at one end of the supporting arm. As shown in the drawings, the supporting arm 2 is secured, at its other end, to one end portion of a leaf spring member 4. The other end portion of the leaf spring member 4 is secured to a pivot bearing 11 (not shown in FIG. 2) via a spring securing member 5.

Thus, the support arm 2 is supported on the pivot bearing 11 in an elastic manner via the leaf spring member 4.

The supporting arm 2 has a pair of projections 11a and 11b (the latter is not shown in FIG. 1) bulging from it. The top portions of the projections 11a and 11b are in contact with the pivot bearing 11 at points Pa and Pb, so that one end of the support arm 2 is biased toward a magnetic recording medium 12 by an elastic force created by the leaf spring member 4, whereby a compressive stress is generated at each of the contact points Pa and Pb. The supporting arm 2 is so constructed that it is brought into the position shown by the broken line in FIG. 1 by deformation of the leaf spring member 4, if the magnetic recording medium 12 were not present.

The projections 11a and 11b bulging from the support arm 2 are so arranged that they are in contact with the support arm 2 on such a line that is perpendicular to the direction of the central axis of swing movement the support arm in a radial direction of the magnetic recording medium 12, perpendicular to the longitudinal direction of the support arm 2, and passing through the central axis of the swing movement.

When the magnetic recording apparatus is operating, namely when the slider 1 is flying above the magnetic recording medium 12, a load on the slider 1 is generated by the compressive stresses in the direction toward the magnetic recording medium 12 which the projections 11a and 11b of the supporting arm 2 receive from the pivot bearing 11.

With the above-described structure of the head supporting mechanism, it is possible to construct the supporting arm 2 with a material having a high rigidity. Therefore, it is possible to construct the head supporting mechanism with a material having a high rigidity in all of the areas ranging from the pivot bearing 11 to the projections 11a and 11b of the support arm and from the projections 11a and 11b to the area on which the slider is provided in the support arm 2.

If the support arm 2 is constructed with a material having a high rigidity, the resonance frequency of the support arm 2 can be made high. Then, a vibration mode that has conventionally mattered would not be generated, and so a settling operation is not required. Therefore, swinging and positioning of the support arm 2 can be performed quickly, and it is possible to enhance the access speed of the magnetic recording apparatus.

In the above-described structure, the leaf spring member 4 serving as elastic means is not built in the structure of the support arm 2, but it is provided as a separate member independent from the support arm 2. Therefore, the strength and the spring constant can be selectively determined by changing the thickness, material or other properties of the leaf spring member 4.

In addition, it is possible to provide a stable head supporting mechanism that is hard to vibrate upon receiving an external impact by designing the head supporting mechanism, in terms of its structure under the condition in which it is used, in such a way that the position of the center of mass of the portion supported by the leaf spring member 4 (for example, in the case in which the swinging is performed by a voice coil motor, the position of the center of mass of the support arm 2 with a voice coil and a coil holder being attached to it) coincides with the intersection point of the axis of swinging of the support arm 2 in the radial direction of the magnetic recording medium 12 and the axis of the swinging of the support arm 2 in the direction perpendicular to the recording surface of the recording medium 12, in other words, in such a way that the position of said center of mass with respect to the horizontal plane substantially coincides with the midpoint P of the line segment between the points Pa and Pb at which the pivot bearing 11 and the projections 11a and 11b of the support arm 2 abut to each other (i.e. as shown in FIG. 2, the distance between point P and point Pa is equal to the distance between point P and point Pb, namely distance L). While the impact resistance of the head support mechanism would be maximized when the above condition is met, the position of the center of mass may, in practice, be displaced to some extent.

Furthermore, when the slider 1 is supported by a gimbal mechanism 13 via a dimple 14 formed on the bottom surface at one end of the support arm 2 as shown in FIG. 1, it is possible to realize a flexible head supporting mechanism that can follow unwanted vibration of the slider 1 in the rolling and pitching directions relative to the magnetic recording medium 12 under the operating state of the magnetic recording apparatus.

As per the above, the head supporting mechanism according to the present invention can meet contradictory requirements, namely an increase in the load for the slider 1, enhancement of the flexibility and enhancement of the rigidity of the structure. The solutions for those requirements are realized as effects of different components that function independently from each other. Therefore, designing of the head supporting mechanism can be made simple and the freedom of design can be increased dramatically.

The head supporting mechanism according to the present invention does not require a high precision processing (such as bending) for forming a leaf spring portion. Therefore, the head supporting mechanism can be produced easily as compared with conventional head supporting mechanisms.

In the following, operations of the head supporting mechanism according to the present invention will be described with reference to FIGS. 1 and 2.

As described before, when the magnetic recording apparatus 12 is not in operation, the slider 1 and the magnetic recording medium 12 are in contact with each other and out of operation. When the magnetic recording medium 12 starts rotating upon a recording or reproducing operation, the slider 1 begins to fly and the leaf spring member 4 deforms, so that the magnetic recording or reproduction is performed with the support arm 2 being in the state depicted by the solid line in FIG. 1, in which a constant spacing is maintained between the magnetic head and the magnetic recording medium 12.

In this case, the reaction force created by the leaf spring portion for returning the support arm 2 toward the position depicted by the broken line in FIG. 1 gives a load applied to the slider 1.

This load can be varied by changing the material or thickness of the leaf spring member 4, the height of the projections 11a and 11b of the support arm 2 or the positional relationship between the support arm 2 and the point G shown in FIG. 1, which is a joint portion of the support arm 2 and the leaf spring member 4.

For example, with a leaf spring member 4 made of a material with a high rigidity and a large thickness, a large load would be applied to the slider 1. Furthermore, a large load can also be applied to the slider 1 by making the height of the projections 11a and 11b of the support arm 2 large or by making the positions of the joint portion G of the support arm 2 and the leaf spring member 4 shown in FIG. 1 close to the point P.

### Second Embodiment

A head supporting mechanism of a magnetic recording apparatus according to the invention, in which the operation principle described in connection with the first embodiment is realized, will be described as a second embodiment.

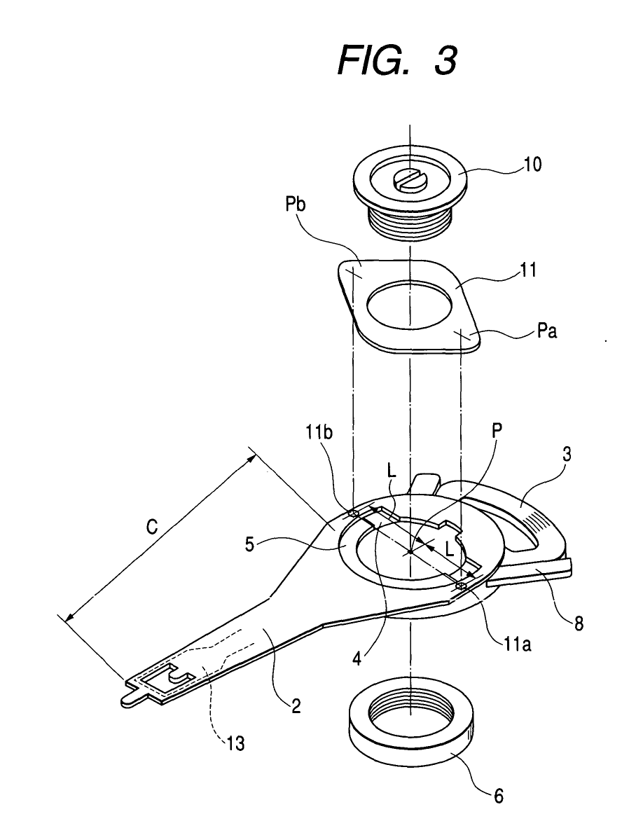

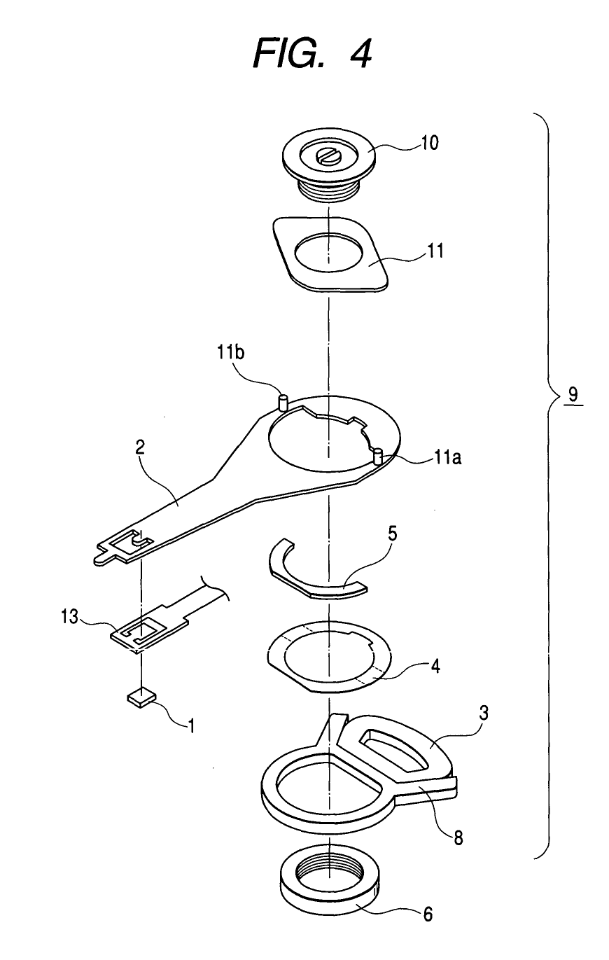

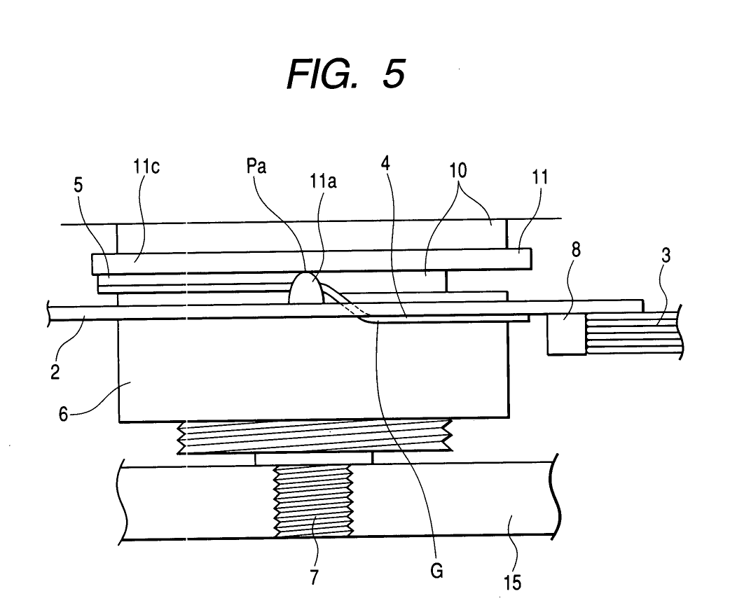

FIG. 3 is a perspective view showing the head supporting mechanism according to the present invention. FIG. 4 is an exploded perspective view showing the head supporting mechanism. FIG. 5 is a side view showing a portion around the bearing of the head supporting mechanism.

As shown in FIGS. 3 and 4, the head supporting mechanism 9 is constructed by joining a leaf spring member 4 having a substantially annular shape and a spring securing member 5 and joining the leaf spring portion with a support arm 2. The support arm 2 is coupled to a coil holder 8 attached with a voice coil 3 so that the support arm 2 would be swingable in a radial direction of a magnetic recording medium 12. These members are held between a bearing portion 10 and a nut 6 together with a pivot bearing 11.

As shown in FIG. 5, the whole of the head supporting mechanism 9 is fixed at its shaft to a base plate 15 with a mounting screw 7 provided on the bearing portion 10.

In the following, a specific description will be made of how the members are joined with each other with reference to FIG. 5. First, the upper surface of the leaf spring member 4 and the lower surface of the support arm 2 are joined at the portion in the right side of the rotation shaft in FIG. 5. In the left side portion, the leaf spring member 4 and the spring securing member 5 are held, together with a collar 11c of the pivot bearing 11, between the bearing portion 10 and the nut 6. The support arm 2 is constructed to be secured to the coil holder 8.

With the above-described structure, the leaf spring member 4 is deformed to bend into two stories, so that a structure in which the support arm is elastically supported is realized.

The bearing portion 10 accommodates a bearing so that the support arm 2 can swing (or pivot) in the radial direction of the magnetic recording medium so as to bring a magnetic head provided on the lower surface at one end of the support arm 2 to a desired position.

Projections 11a and 11b are provided on the support arm 2 in such a way that they are in contact with the pivot bearing 11 on the line that is perpendicular to both the axial direction of the bearing portion 10, perpendicular to the longitudinal direction of the support arm and passing through the center of the pivot movement of the bearing portion 10 in the radial direction of the magnetic recording medium.

The projections 11a and 11b of the support arm 2 are provided at positions that are symmetrical with respect to the center line in the longitudinal direction of the support arm 2. The pair of the projections 11a and 11b are adapted to be in contact (point contact) with the pivot bearing 11 so that the support arm 2 would be pressed downward by its reaction force.

In addition, it is possible to provide a stable head supporting mechanism that is hard to vibrate upon receiving an external impact by designing the head supporting mechanism in such a way that the position of the center of mass of the portion supported by the leaf spring portion (i.e. the position of the support arm 2 with a voice coil and a coil holder being attached to it) coincides with the midpoint P of the line segment between the points Pa and Pb at which the pivot bearing 11 and the projections 11a and 11b of the support arm 2 abut to each other (as shown in FIG. 2, the distance between point P and point Pa is equal to the distance between point P and point Pb, namely distance L). While the impact resistance of the head support mechanism would be maximized when the above condition is met, the position of the center of mass may, in practice, be displaced to some extent.

Furthermore, the head supporting mechanism 9 may be designed taking into account the weight of the slider 1 and the gimbal mechanism so that the position of the center of mass of the support arm 2 with the voice coil 3, the coil holder 8, the slider 1 and the gimbal mechanism attached thereto would substantially coincide, on a horizontal plane, with the position of the point P.

Referring to individual members, the support arm 2 is formed as an integral member made of a metal such as a stainless steel (e.g. SUS304) with a thickness of 64 μm. The support arm 2 may be formed by etching or press working.

With such a support arm 2, the resonance frequency can be raised from about 2 kHz in the conventional support arms up to as high as about 10 kHz. Therefore, it is possible to provide a magnetic recording apparatus having an increased swing speed of the head supporting mechanism and an increased access speed, as compared to conventional apparatus.

In order to enhance rigidity of the support arm 2 with respect to the longitudinal direction, a bent portion with a height of 0.2 mm may be formed in the direction perpendicular to the recording surface of the magnetic recording medium, in the area C of the front end portion of the support arm 2 shown in FIG. 3.

Referring to FIG. 4, the slider 1 is supported by the gimbal mechanism 13 via a dimple (not shown) in such a way that it can be inclined in the rolling and pitching directions. The slider 1 is provided with a magnetic converting element on its side opposed to the magnetic recording medium 12.

The spring securing member 5 is formed as a member made of a metal such as a stainless steel (e.g. SUS304) with a thickness of 0.1 mm. The leaf spring member 4 is formed as a member made of a metal such as a stainless steel (e.g. SUS304) with a thickness of 38 μm. These members may be produced or processed by etching or press working.

The coil holder 8 is formed as a member made of a metal such as aluminum or PPS (poly-phenylene sulfide) with a thickness of 0.3 mm. When the aluminum is used, the coil holder 8 may be produced by die casting or press working, while when the PPS is used, it may be produced by known resin molding.

Joining of parts may be performed by known methods such as a spot welding, ultrasonic welding and laser welding etc.

It should be understood that in the present invention, there is no limitation for process for manufacturing each part or process for joining parts.

With the above-described structure, it is possible to provide a head supporting mechanism in which the principle having been described in connection with the first embodiment can be realized.

With the above-described structure of the head supporting mechanism 9, the support arm 2 can swing freely in the direction perpendicular to the recording surface of the magnetic recording medium with the projections 11a and 11b on the support arm being the fulcrum, namely the support arm 2 can operate in a novel manner that has not been enabled in conventional structures.

Specifically, in the conventional CSS (contact start stop) magnetic recording apparatus, it has not been possible to move the support arm 2 freely in the up-and-down directions. Consequently, it was necessary to make the surface of the CSS area coarser than the surface of the data storage area in order to prevent the slider from adhering to the surface of the magnetic recording medium when the apparatus is out of operation. However, in the head supporting mechanism according to the present invention, the support arm 2 can be moved up and down using some known means, and the support arm can be kept slightly apart from the magnetic recording medium 12 when the magnetic recording medium is out of operation. Therefore, it is not necessary to provide a refuge site such as a CSS area, for the magnetic head on the magnetic recording medium.

On the other hand, in the case of a magnetic recording apparatus using a L/UL (load/unload) system, it is also possible, with use of the head supporting mechanism according to the present invention, to keep the support arm 2 slightly apart from the magnetic recording medium 12 when the magnetic recording apparatus is out of operation. Therefore, it is possible to minimize a wasteful area on the magnetic recording medium for allowing loading and unloading of the magnetic head, which is provided in conventional apparatus.

While the foregoing description has been directed to an embodiment of the present invention in the form of a head supporting mechanism in a magnetic recording apparatus using a magnetic head, the head supporting mechanism according to the present invention may also be used as a head supporting mechanism for a non-contact disk recording/reproducing apparatus such as an optical disk apparatus and magneto-optical disk apparatus etc. to attain advantageous effects similar to those described above.

In the first and second embodiments described above, the projections 11a and 11b bulging from the support arm 2 are formed and made into point contact with the plate-like pivot bearing 11 serving as a part of bearing portion. This structure has the following advantage over the structure in which a projecting portion(s) is provided on the pivot bearing. The support arm 2 is generally made using a thin plate in order to reduce the weight or in view of spatial limitations in the thickness direction of the magnetic recording apparatus. Therefore, if the projecting portion(s) is formed on the pivot bearing 11, the projection will be in point contact with the support arm 2 and an impact force will be concentrated on the support arm made of a thin plate, so that a defect such as a deformation can be produced in the support arm. However, in the structure according to the first and second embodiments, the projecting portions are provided on the support arm and the projecting portions are in the form of projections bulging from the support arm. Therefore, the limited area of the support arm is increased. Consequently, an impact force will be received by a portion in the periphery of the projecting portions, so that stress will be reduced and it is possible to prevent a defect such as a deformation from being produced in the support arm.

While in the above-described embodiments, two projections 11a and 11b are formed side by side in the width direction on the support arm, the number of the projecting portions is not limited to two, but the number of the projecting portions may be increased. In addition, the shape of the projecting portions may be modified from a hemispherical shape to, for example, a semi-cylindrical shape to increase the limited area. In connection with this, how the projecting portions are formed will be described in the following description of a third embodiment.

### Third Embodiment

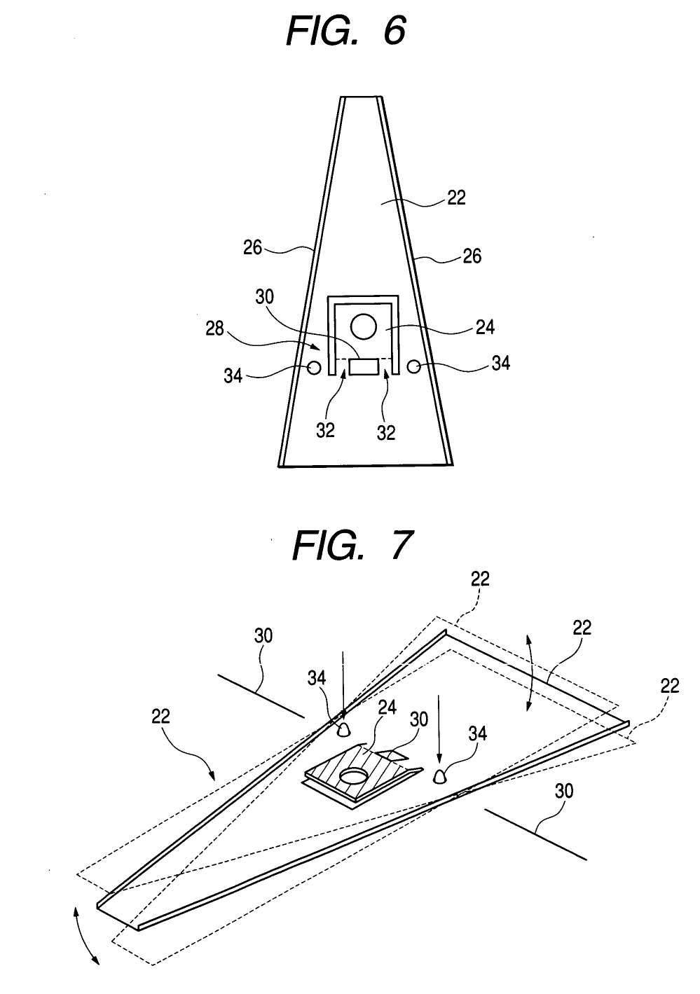

FIG. 6 is a plan view showing the structure of the magnetic head apparatus according to a third embodiment of the present invention. As shown in FIG. 6, the magnetic head apparatus 20 according to the third embodiment has a load beam 22 having an outer shape like an isosceles triangle. On an inner portion of the load beam 22, there is provided a base plate 24 functioning as a mount portion to be attached to a head arm (which will be described later).

The load beam 22 is made by press working or etching a thin metal plate. More specifically, the thin metal plate is a non-magnetic stainless steel (e.g. an austenite stainless steel). The edges of the load beam 22 corresponding to the two isometric sides of the isosceles triangle shape are formed into bent portions 26. Each bent portion 26 is formed by bending the edge of the load beam 22 at a certain angle or bending the edge into a half round shape (i.e. semi-cylinder shape). With the provision of the bent portions 26, rigidity with respect to the longitudinal direction of the load beam 22 can be assured.

At the center of the load beam 22 between the bent portions 26 formed at the right and left edges, a slit 28 of an inverted U-shape (in FIG. 6) is formed. The tongue surrounded by the slit 28 is adapted to serve as the above-mentioned base plate 24.

The boundary portion between the base plate 24 and the load beam 22 (namely, the portion along line 30 in FIGS. 1 and 2) functions as a cantilevered leaf spring portion 32 that serves as an elastically deformable portion. At positions slightly offset from above or below line 30 on the load beam 22, there is provided a pair of projections 34 bulging from the load beam 22. Thus, after the base plate 24 is fixed, the load beam 22 can swing or pivot about line 30 upon receiving pressing force applied externally of the magnetic head apparatus 20 on the top of the projections 34. The swinging of the load beam 22 in response to the application of a pressing force is illustrated in FIG. 7.

At the tip end portion (i.e. the upper end portion in FIG. 6) of the load beam 22, a slider 36 (see FIG. 3) in which an element for performing writing/reading of a recording medium is assembled is mounted via a gimbal (not shown).

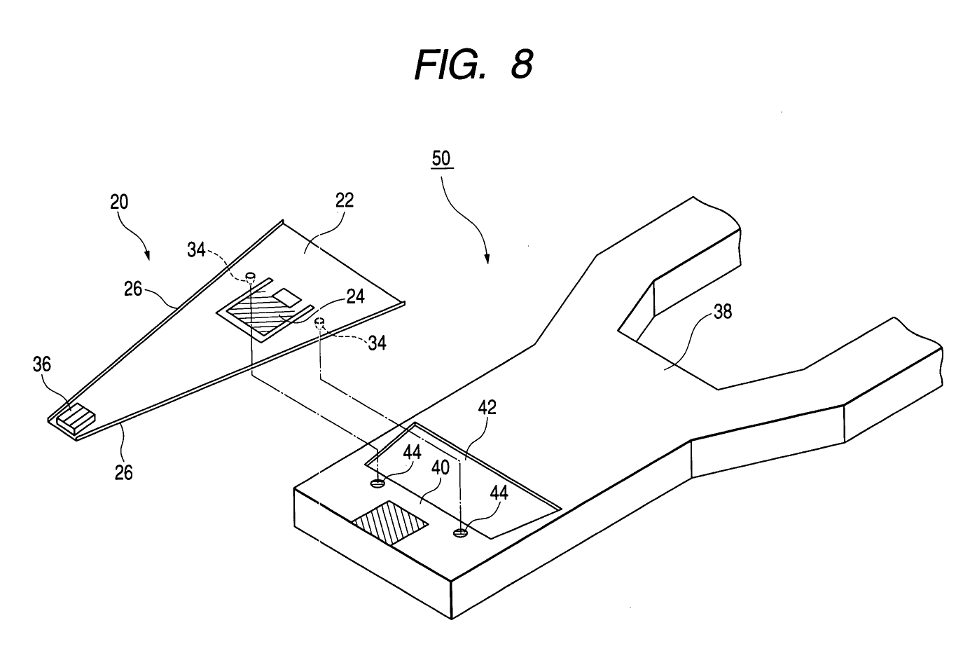

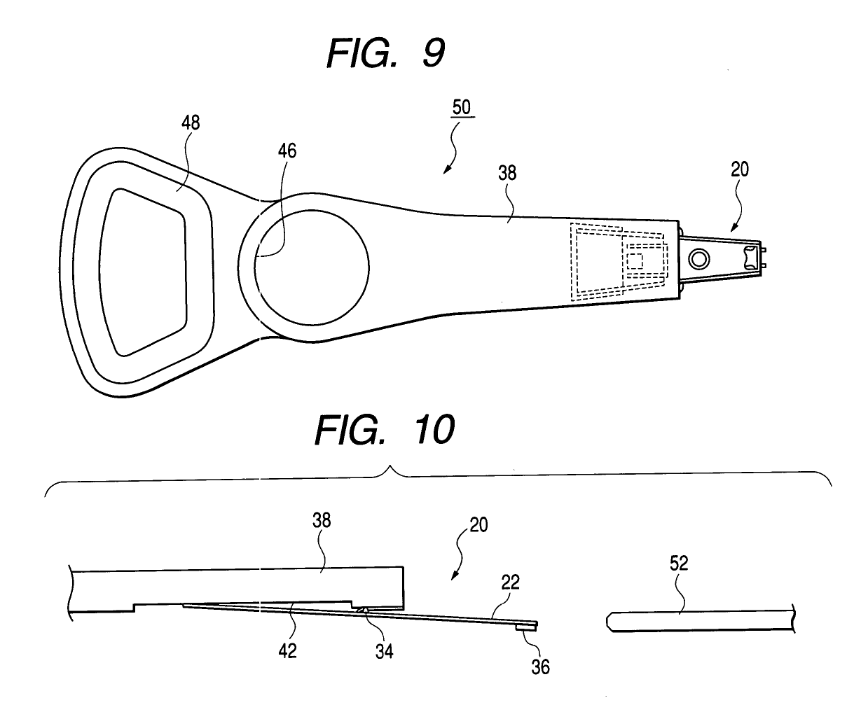

FIG. 8 is an exploded view showing how the magnetic head apparatus and a head arm are assembled in relation to each other. FIG. 9 is a front view of a magnetic head supporting mechanism formed by mounting the magnetic head apparatus to the head arm.

As shown in FIGS. 8 and 9, at the tip end portion of the head arm 38 to which the magnetic head apparatus 20 is to be mounted, there is provided a plate mounting surface 40 to which the base plate 24 is to be fixed. The size of the plate mounting surface is the substantially the same as the size of the base plate 24 in the magnetic head apparatus 20. The head arm 38 has a recess 42 formed at the periphery of the plate mounting surface 40. The recess 42 has the width sufficient for receiving the width of the load beam 22, so that when the magnetic head apparatus 20 is assembled with a recording medium, the rear end portion of the load beam 22 is prevented from interfering with the head arm 38. If the magnetic head apparatus in a flying state does not obstruct loading, the recess 42 may be omitted.

On the surface of the head arm 38, there is further provided a pair of extrusive surfaces 44 adapted to be in contact with the projections 34, at positions that are closer to the tip end than the plate mounting surface 40. When the base plate 24 is aligned with the plate mounting surface 40, the projections 34 formed on the load beam 22 are aligned with the extrusive surfaces 44 so that the extrusive surfaces would press the top of the projections.

The head arm 38 is provided with a center hole 46 in which a bearing is accommodated and a coil 48 for constituting a VCM (i.e. voice coil motor) disposed on the rear side of the center hole 46. The head arm 38 can swing about the center hole 46 with supply of electrical power to the coil 48. It is desirable that the magnetic head supporting mechanism 50 including the magnetic head apparatus 20, the head arm 38 and the coil 48 be balanced with respect to the center hole 46, in order to minimize influences of external disturbances.

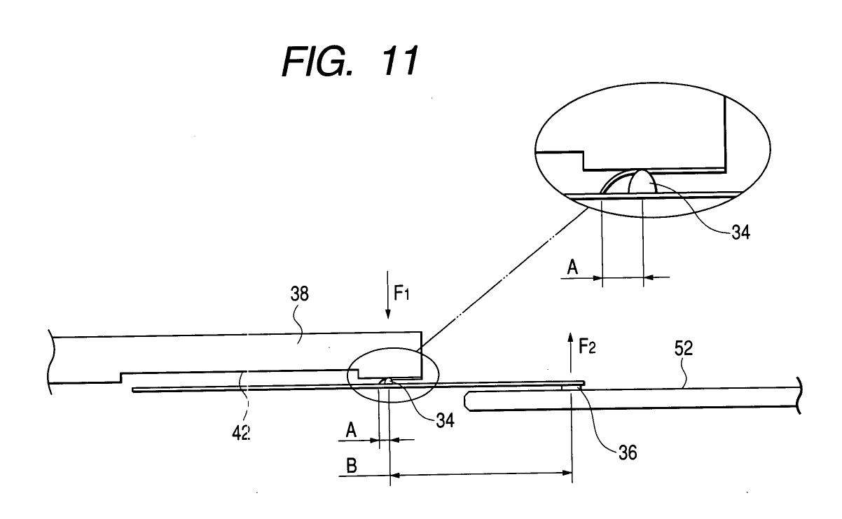

FIGS. 10 and 11 are drawings illustrating how the magnetic head apparatus according to the present embodiment is assembled to the recording medium.

As shown in FIG. 10, the magnetic head apparatus 20 according to the third embodiment is first fixed to the head arm 38 by spot welding or other attaching processes. When the magnetic head apparatus 20 is fixed to the head arm 38, the pair of extrusive surfaces 44 (not shown in FIGS. 10 and 11) press projections 34 of the load beam 22 to cause the load beam 22 to swing in such a way that the slider 36 is lowered relative to the recording medium 52. In this process, the load beam 22 can swing without being flexed, since rigidity is assured by the bent portions 26 (not shown in FIGS. 10 and 111) formed at both the edges. Even when the load beam 22 is swung by pressure applied by extrusive surfaces 44, the rear end of the load beam 22 does not interfere with the head arm 38 by virtue of the presence of the recess 42 formed on the head arm 38 in the rear side of the mounting surface 40 (not shown in FIGS. 10 and 11). (In other words, the recess 42 should be formed with the depth that is sufficient for preventing the interference in accordance with the inclination of the load beam 22.) Therefore, it is also possible to prevent dust from being generated by interference of the parts.

As shown in this drawing, after the magnetic head is fixed to the head arm 38, the load beam 22 is swung, by means of a jig, in such a way that the slider 36 comes to a position higher than the surface of the recording medium 52, and then the slider 36 is landed (or loaded) on the surface of the recording medium 52. FIG. 11 shows the apparatus in this state. In the state shown in FIG. 6, the following condition is met, where A represents the distance from the top of the projections 34 for creating load to the junction of the leaf spring and the load beam, B represents the distance from the top of the projections 34 to the slider 36, F₁ represents the pulling-up force of the leaf spring and F₂ represents the reaction force exerted to the slider 36 by the recording medium 52 (a loss that might occur due to deformation is ignored):

F₁·A=F₂·B (conditional expression 1).

In other words, the moment about the projections 34 created by the pressing force is equal to the moment created by the reaction force. Therefore, the reaction force of the recording medium 52 that influences the flying characteristics of the slider can be set or adjusted by adjusting the height of the projections 34.

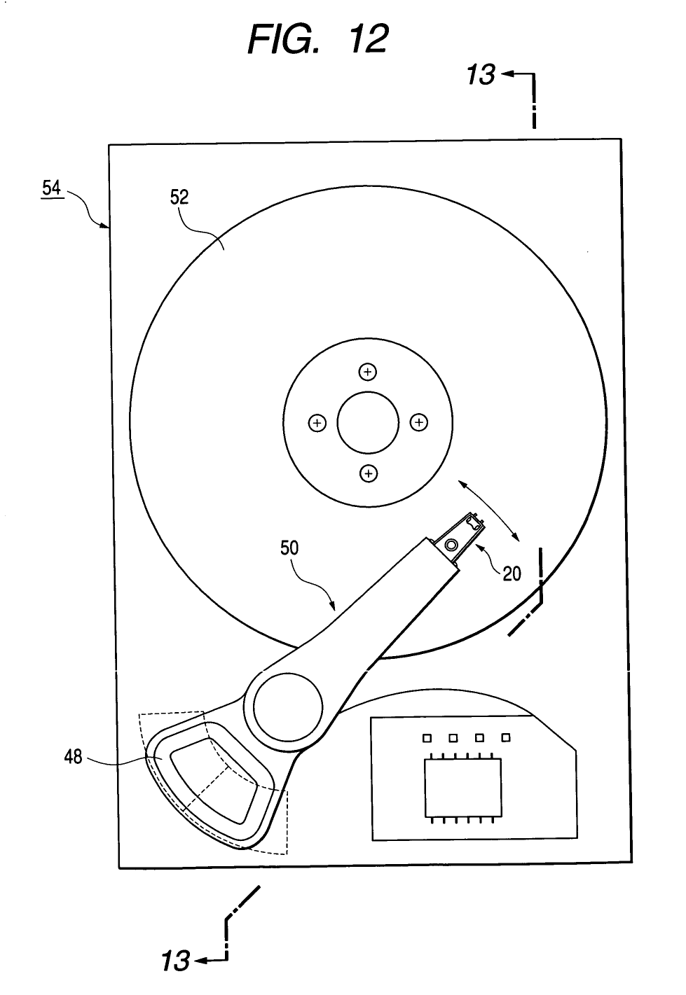

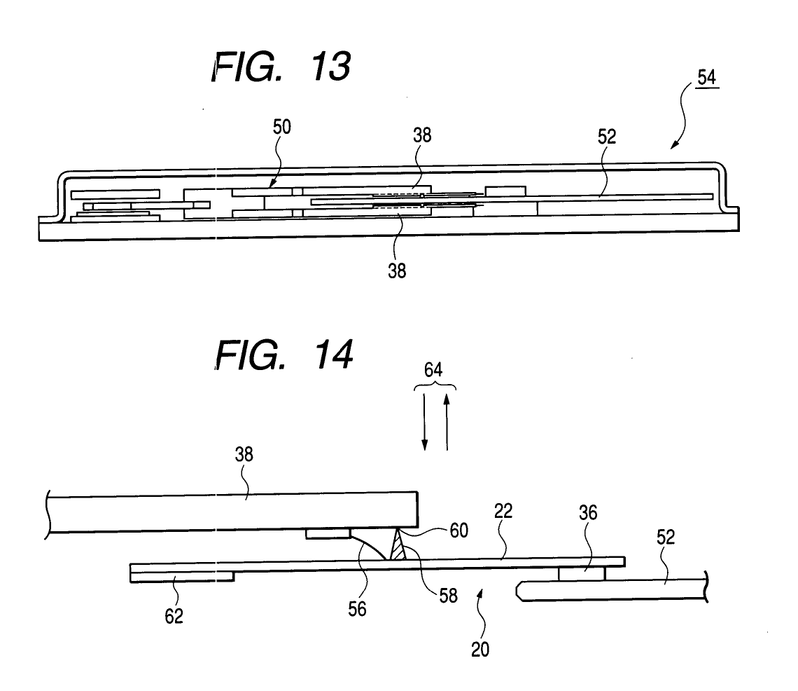

FIG. 12 is a plan view showing a magnetic recording apparatus equipped with the magnetic head or the magnetic head supporting mechanism according to the present invention. FIG. 13 is a cross sectional view taken at line 13-13 in FIG. 12.

The distinguishing features of the magnetic recording apparatus shown in these drawing reside in the magnetic head supporting structure 50 and its peripheral structures, and other parts of the apparatus such as a spindle motor for rotationally driving the recording medium 52 are the same as those in conventional apparatus. Therefore, a magnetic recording apparatus 54 having improved impact resistance can be realized only by substituting the magnetic head supporting structure 50 for that in a conventional apparatus.

FIG. 14 is a schematic drawing for illustrating the impact resistance performance of the magnetic head apparatus according to the third embodiment.

As shown in FIG. 14, the head arm 38 and the load beam 22 are connected by the elastically deformable portion 56, and the extrusive surface 60 of the head arm 38 is pressed by the contact portion 58 provided on the load beam 22. The weight of the magnetic head apparatus 20 is arranged to be balanced with respect to the projecting portion 58. The balancing of the weight may be realized by adjusting the position of the elastically deformable portion 56 on the load beam 22 and/or attaching a dead weight 62 on the load beam 22 at a position opposite to the slider 36 as shown in FIG. 14. In addition, if the dead weight 62 is made of a vibration damping member (or damper), it is possible to reduce the peak value of resonance with respect to the magnetic head apparatus 20, to thereby stabilize a control system (for positioning etc.) of the magnetic recording apparatus 54.

By virtue of the balanced weight of the magnetic head apparatus 20 with respect to the projecting portion 58, even if an impact is applied on the apparatus in the direction of arrows 64 shown in FIG. 14, no rotational force is created in the load beam 22. Thus, the slider 36 is prevented from being detached from the surface of the recording medium 52 when a strong impact is applied. Therefore, it is possible to eliminate adverse effects such as damaging of elements assembled in the slider 36 or a defect on the recording medium 52 formed by collision with the slider 36.

In the apparatus according to this embodiment, since only the load beam 22 and the parts attached thereto (i.e. the slider 36 and the dead weight 62) are constructed as a floating structure via the elastically deformable portion 56, the mass suspended by the spring (i.e. the total mass of the load beam 22 and the parts attached thereto) below the elastically deformable portion 56 would be reduced. Letting W be the mass of the load beam 22 and the parts attached thereto suspended by the elastically deformable portion 56, Fₛ be a pressing force applied to the load beam 22 by the contact portion 58, and a be an impact acceleration created in the load beam 22 and the parts attached thereto, the following relation is met:

Fₛ=W·a (conditional expression 2).

The inventors estimated by calculation the degree of improvement in impact resistance realized by the present invention. Assuming the mass W=30 mg (milligrams) and Fₛ=120 g (grams), the above relation is as follows:

120=0.03·a, therefore

a=4000.

This means that as far as the impact acceleration is smaller than 4000 G, it is possible to prevent the load beam 22 from detaching from the loading projections 44, and therefore, the slider 36 can be prevented from detaching from and colliding with the recording medium. Thus, the impact resistance can be greatly enhanced as compared to conventional apparatus. In addition the impact resistance of the magnetic head apparatus 20 according to this embodiment does not depend on the length of the head arm, namely it does not depend on the size of the recording medium 52.

The material of the load beam 22 is not limited to the above-described thin metal plate, but other materials can also be used as long as rigidity is assured.

The inventors have discovered that a resin may also be used as a material for the load beam 22 instead of the thin plate of a stainless steel that have been conventionally used. With the use of a resin for the load beam 22, the mass suspended by the spring portion would be further reduced, and therefore the impact resistance performance can be improved still more. The inventors found that resins suitable for the load beam 22 are liquid crystal polymer resins or PPS resins that have electric conductivity, in view of their ability of preventing ESD (i.e. electro static discharge). It is desirable that the specific volume resistance of these resins be smaller than 10⁵ Ωcm.

Even a resin that does not have electric conductivity can also be effectively used if a metal coating is formed by plating etc. on the surface of the load beam 22 after it is injection molded so that its electrical potential would be always kept equal to the potential of the head arm 38.

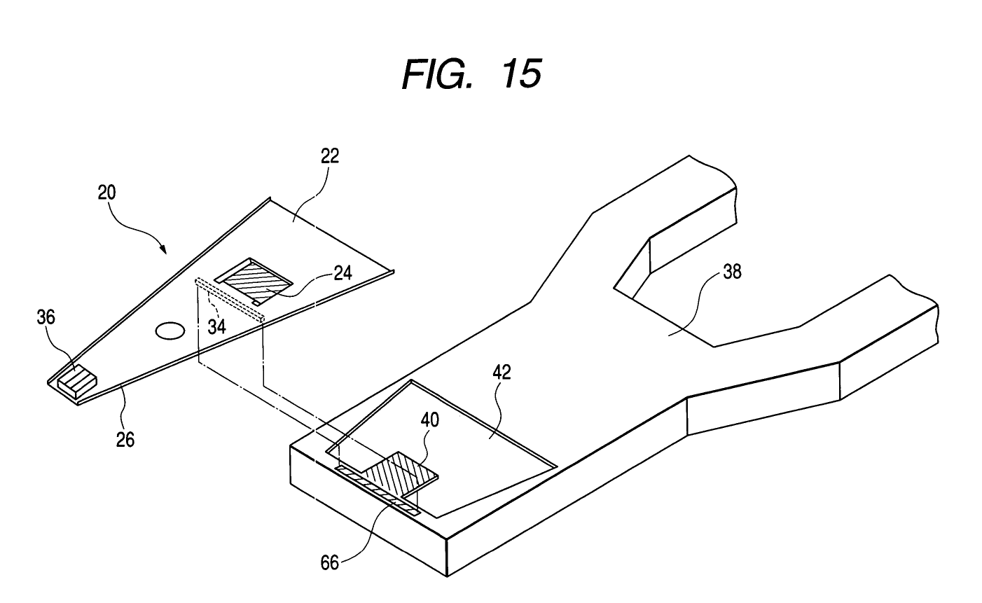

FIG. 15 is an exploded view showing a modification of the magnetic head apparatus according to the third embodiment. In FIG. 15, parts having the same functions as the parts in the above-described embodiment are designated with the same reference numerals and descriptions thereof will be omitted.

In the structure of the modification shown in FIG. 15, the orientation of the slit and the spring portion is reversed and the projecting portion 34 is formed as a part extending transversely to the load beam on the slider side of the base plate with the spring portion between to create a load. In this case also, the center of mass (or the balanced fulcrum) about the load beam 22 is adapted to coincide with the projecting portion 34. In this structure, a necessary load can be provided as long as the conditions of the above-described principles are met, and the structure has good stability against an impact.

As per the above, the magnetic head apparatus, the magnetic head supporting structure and the magnetic recording apparatus according to the third embodiments have improved impact resistance that does not depend on the size or the number of the recording medium(s).

While the foregoing description of the embodiments has been made of a magnetic recording apparatus 54 of a CSS (contact start stop) type, the invention is not limited to the apparatus of that type. The invention may also be applied to an apparatus of a ramp load type in which a tab is provided at the tip of the load beam 22, which allows the slider to be retracted from the surface of the recording medium when it is not operated. In the apparatus of the ramp load type, when the apparatus is out of operation, the slider is riding on a ramp so that the slider and the recording medium are protected, while when the apparatus is under operation the slider and the recording medium are protected by the structure according to the embodiment. Therefore, reliability of the magnetic recording apparatus can be greatly enhanced.

As described before, in order to realize a track seeking operation on the magnetic recording medium, it is necessary to provide a support member for a head gimbal assembly. This support member, which is referred to as an arm, is constructed as a part extending from a pivot bearing portion in the direction toward the medium. In view of spatial requirements in the interior of the magnetic recording apparatus, the supporting arm is generally constructed by a thin plate made of aluminum or a stainless steel. However, such a thin plate does not have sufficient strength against an impact that may be applied to it, and therefore the support arm can deform at its free end when acceleration is generated by an impact. This sometimes causes a crash of the head assembly attached on the tip of the arm. In order to solve this problem, a strengthen plate(s) is attached to a head arm assembly including one or more head arms in order to enhance the strength of the arms against impact acceleration. The strengthen plate is attached to a side of the head arm assembly other than the side facing the recording medium in such a way that the strengthen plate extends perpendicular to that side of the arm assembly.

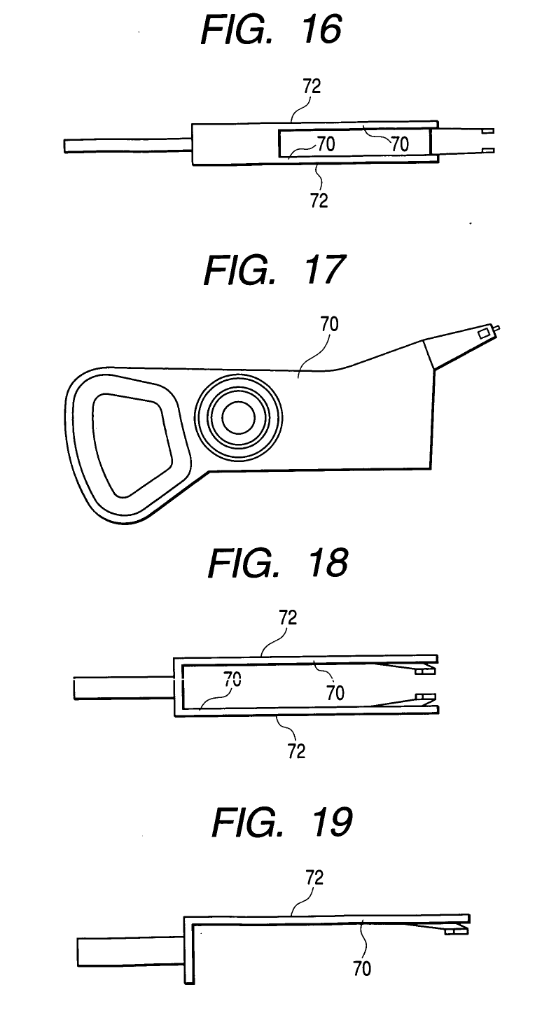

As described above, in the magnetic head apparatus, the balanced fulcrum about the load beam is adapted to coincide with the projection formed on the load beam. With this feature, the impact resistance of the magnetic head itself has already been enhanced. The provision of the strengthen plate(s) attached to the arm gives a rib structure to the arm. Thus, it is possible to prevent deformation from occurring at the mount portion of the magnetic head apparatus when an external impact is applied to it. The arms 72 to which the strengthen plates 70 are attached are shown in FIGS. 16 to 19.

In the above-described third embodiment, the projections 34 formed on the load beam 22 are adapted to be in contact with the extrusive surface 44. This structure has the following advantage over the structure in which a projection(s) is provided on the extrusive surface.

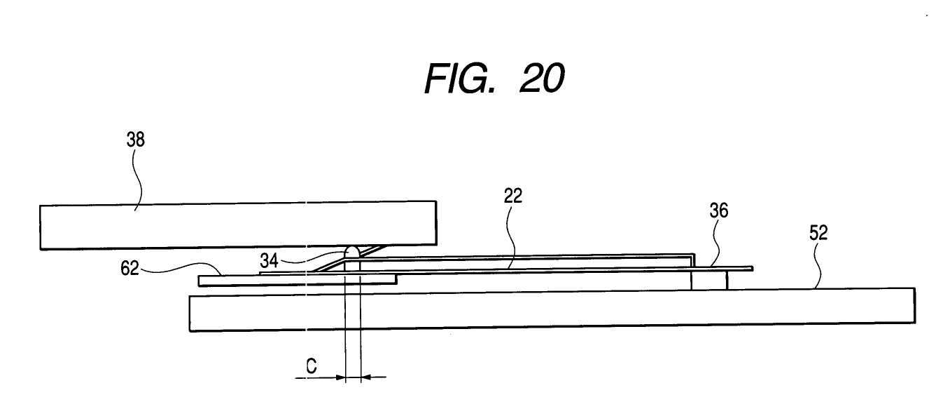

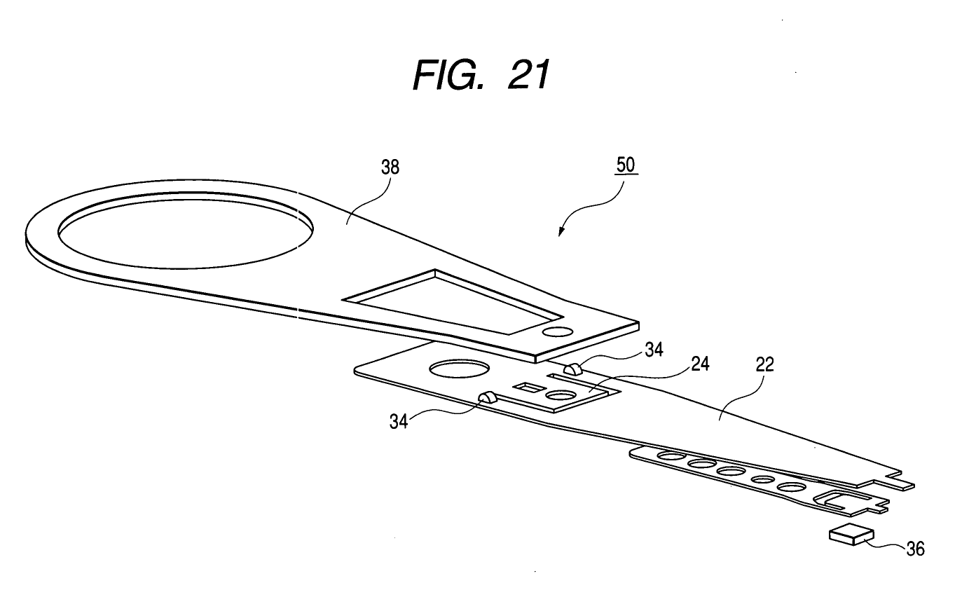

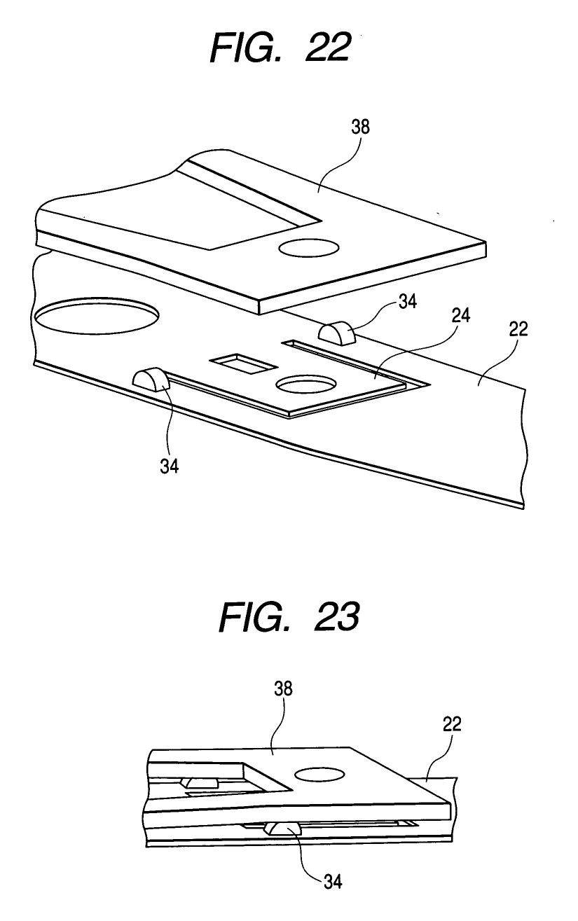

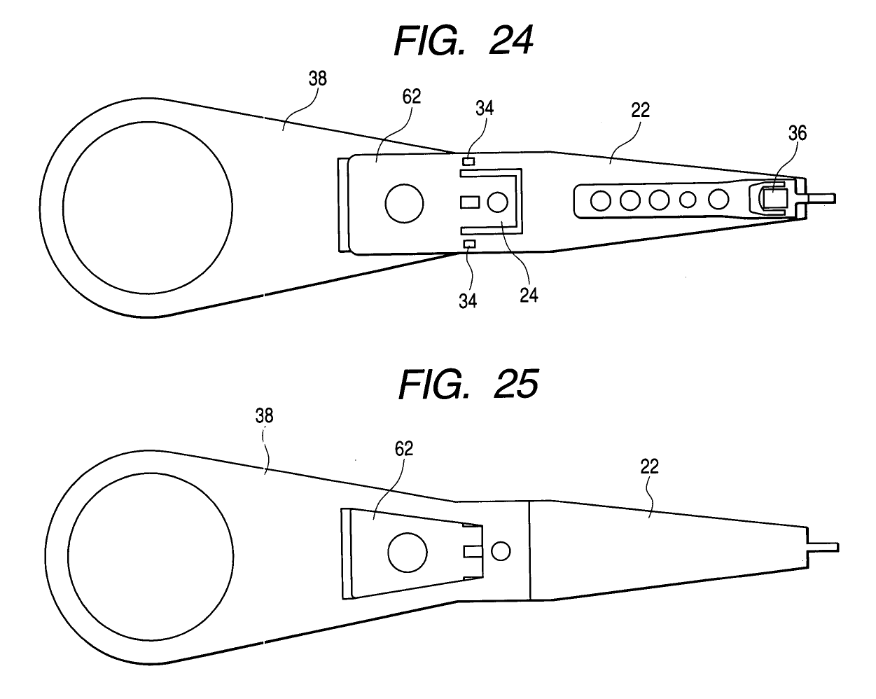

FIGS. 20 to 25 are drawings for illustrating the advantage of the projection formed on the load beam. FIG. 20 is a side view of the head supporting mechanism. FIG. 21 is an exploded view showing parts of the head supporting mechanism. FIG. 22 is an enlarged view showing a portion of the structure shown in FIG. 21. FIG. 23 is a perspective view showing how the head arm and the load beam are joined. FIG. 24 is a front view showing the magnetic head apparatus and the head arm that are assembled together. FIG. 25 is a back view showing the magnetic head apparatus and the head arm that are assembled together.

The load beam 22 is produced from a thin plate made of a metal (more specifically, a thin plate of a non-magnetic stainless steel (austenite or the like)) by press working or etching. In such a load beam, if a projection(s) is formed on the plate mounting surface 40, the projection(s) will be in point contact with the load beam 22, and therefore, when an impact force is applied, it would concentrate on the load beam 22 that is made of a thin plate. Therefore, it is considered that the load beam might deform. However, in the structure of the third embodiment, the projections 34 are formed on the load beam 22 in such a way that they bulge from the load beam 22. Thus, the limited area of the load beam 22 is increased (see dimension C in FIG. 20). Consequently, an impact force is received in the periphery of the projections, so that a stress is reduced and the damages such as deformation of the load beam 22 can be prevented from occurring. While in the above-described third embodiment, the projections 34 formed on the load beam 22 are of a hemispherical or a bar shape, the shape of the projections is not limited to them. In other words, the number of the projections 34 may be increased or the shape of the projections may be modified from the hemispherical shape to, for example, a semi-cylindrical shape (see FIGS. 21 and 22) in order to increase the limited area.

The inventors estimated the stress reduction effect expected with the present invention by comparing the case in which a projection(s) is formed on the head arm and the case in which a projection(s) is formed on the load beam. According to a simulation analysis performed by the inventors under the assumption that each of the projections has a hemispherical shape with an inner diameter of 0.1 mm, the plate thickness is 40 μm and the load applied to the projections is 1 gf, the maximum stress in the structure in which the projections are formed on the load beam is 2.488E+007 (N/m²), while the maximum stress in the structure in which the projections are formed on the surface opposed to the load beam is 1.1236E+008(N/m²). Namely, the degree of concentration of stress can be reduced to about 22%.

With this result, it would be understood that when the load is concentrated to the points at which the projections abut, the stress is not distributed over a large area but concentrated at a single position. Therefore, when an impact is applied, this difference results in the difference in a plastic deformation area, and therefore the advantages of the structure according to the present invention is confirmed.

In the following, a process for forming the above-described projections will be described.

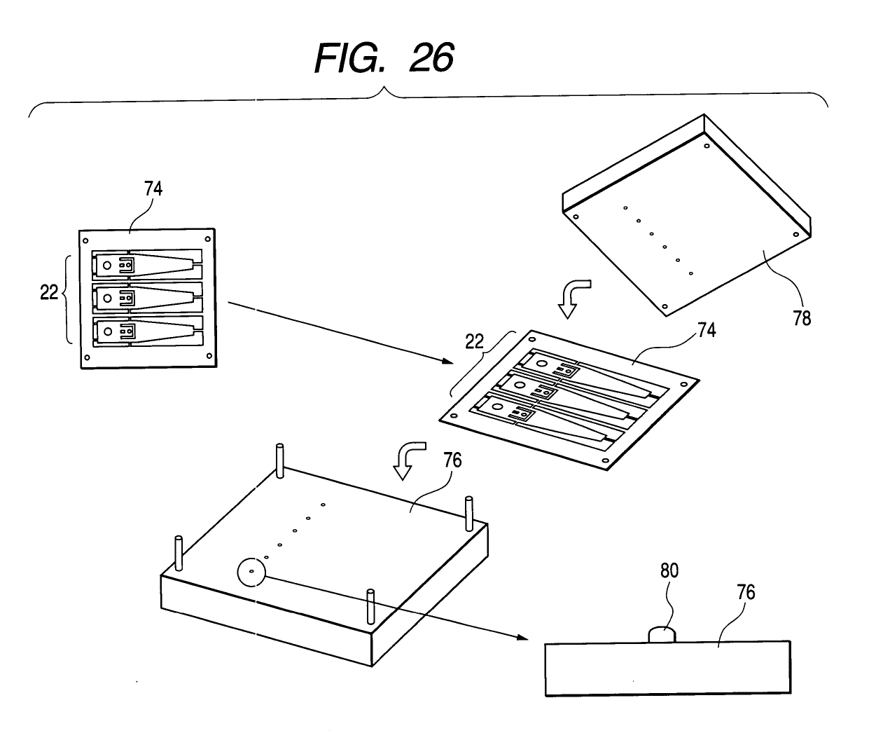

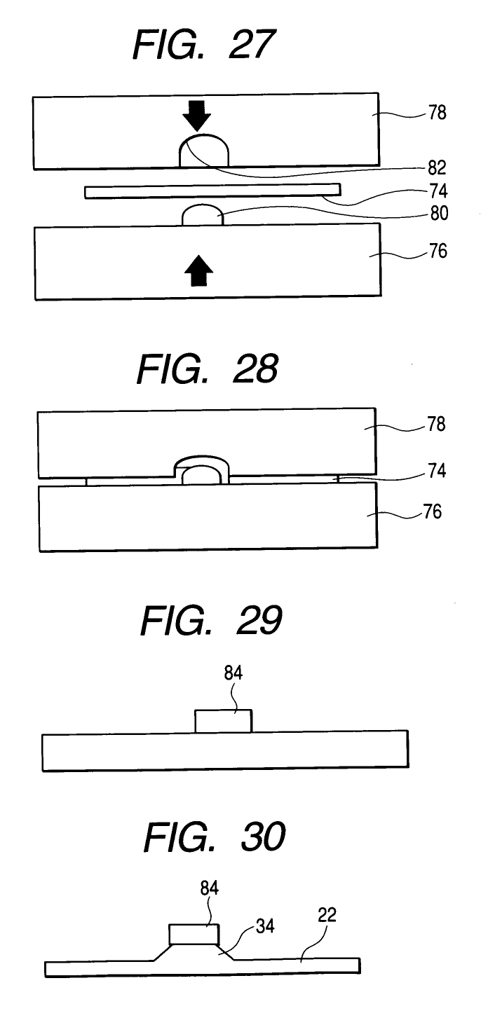

FIG. 26 is a drawing illustrating a process for forming projections using press working. As shown in this drawing, in the process for forming the projection 34 on the load beam, the contour of multiple load beams 22 is first formed by etching. The thin plate 74, on which the contour of the load beams 22 has been formed by etching, is then attached to a lower (or bottom) stamp 76. The lower stamp 76 has convex portions 80 formed on the upper surface of it for forming the projections 34. The convex portions 80 are adapted to be fitted with concave portions 82 formed on an upper (or top) stamp 78 with the load beams 22 between to form the projections 34. The process for forming the projections 34 by fitting the upper stamp 76 with the lower stamp 76 is shown in FIGS. 27 and 28. With such a pressing process, projections 34 having various shapes (e.g. a semi-cylinder shape) can be formed in accordance with requirements, by changing the shapes of the convex portions 80 and the concave portions 82.

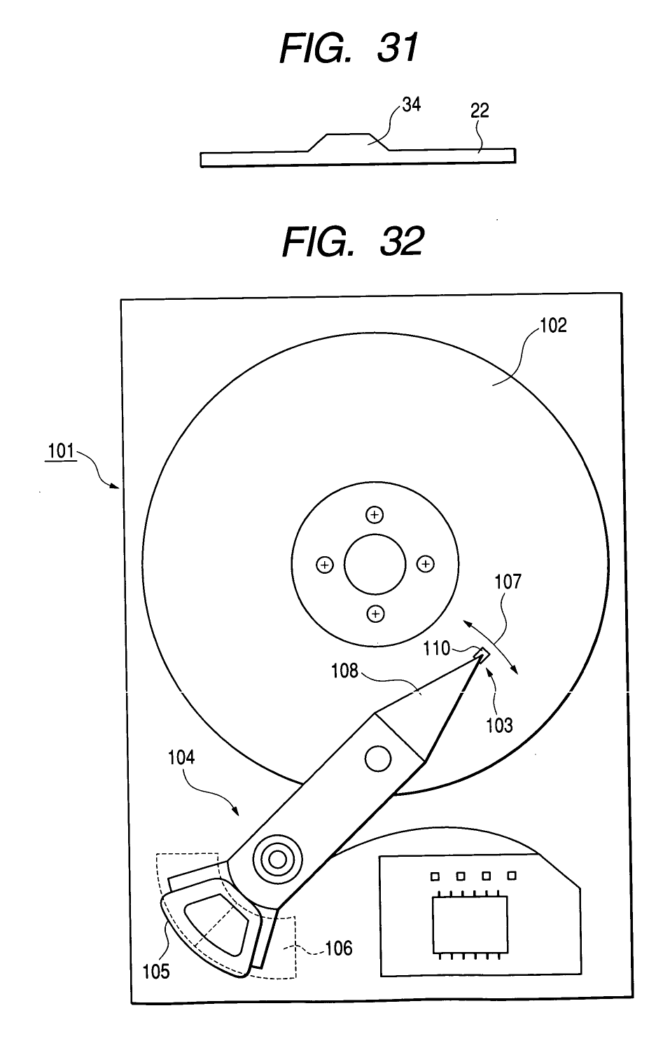

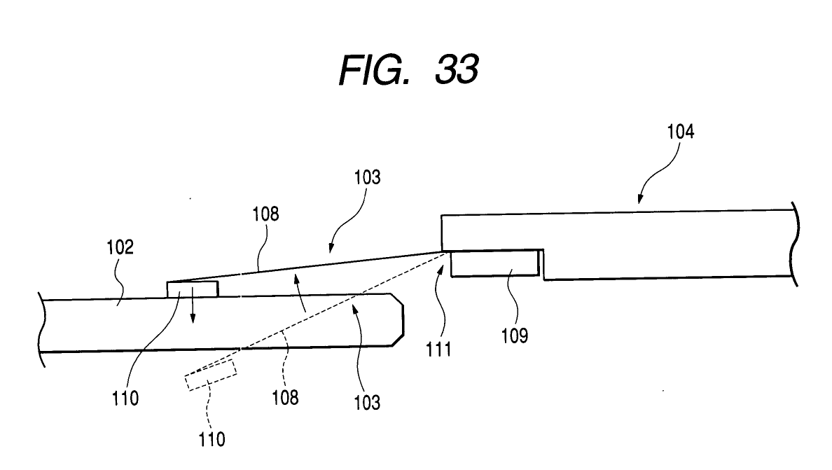

FIGS. 29 to 31 are drawings illustrating a process for forming the projections by etching. As shown in these drawings, the above-mentioned projections 34 can be formed not only by press working but also by etching. As shown in FIG. 29, a mask 34 is applied to a plate at a position at which each projection 34 is to be formed. Then, as shown in FIG. 30, the plate is etched by an etchant until a projection 34 with a predetermined height is formed. In the case of forming the projections by etching, the plate thickness should be determined in advance before the etching taking into account an appropriate thickness of the load beam 22 to be obtained after the etching. When the etching has progressed up to the height of the projections 34, the etchant is washed away to stop the progress of the etching, and the mask 84 remaining on the projection 34 is taken away. Generally, the projection 34 formed by etching has a trapezoidal form, which shape also increase the limited area of the load beam 22, Therefore, it is possible to prevent a plastic deformation of the load beam 22 from occurring when an impact is applied to it.

While the above-described process for forming the projections 34 has been described in connection with the load beam 22, the processes may be also applied to the support arm. In addition, the projection 34 may be formed not only by a wet etching process using a etchant but also by a dry etching process.

As has been described in the foregoing, in the magnetic head apparatus according to the present invention, an elastically deformable portion is formed on a load beam attached with a slider so that a floating structure that allows the load beam to swing is formed about the elastically deformable portion, an projection bulging from the load beam serving as a load generating portion is adapted to coincide with a balanced fulcrum about the load beam, and a pressing load of the slider against a recording medium is adapted to be set by a pressure applied to the top of the projection.

Furthermore, a head supporting mechanism according to the present invention is constructed as a magnetic head supporting mechanism having a magnetic head apparatus provided with a base plate and a load beam extending from the base plate, a head arm attached to the base plate, an elastically deformable portion that is flexible provided between the base plate and the load beam so that a floating structure that allows said load beam to swing is formed about said elastically deformable portion, and a projection bulging from the load beam provided as a load generating portion, wherein the projection is adapted to coincide with a balanced fulcrum about the load beam. The magnetic head supporting mechanism is adapted to apply a pressing load to a recording medium via a slider attached to the load beam, and the pressing load of the slider is set by a pressure applied to the top of the projection from the head arm. A magnetic head supporting mechanism according to another mode of the present invention has a support arm swingable in a radial direction of a recording medium and in a direction perpendicular to a recording surface of the recording medium with a bearing portion being a pivot, a head attached to a lower surface of the support arm at one end of the support arm, elastic means provided on the support arm for imparting a biasing force in the direction toward the recording medium to the support arm, and a projection bulging from the support arm adapted to be in point contact with a part of bearing portion, wherein the support arm is adapted to be swingable in the direction perpendicular to the recording surface, with a point at which the top of the projection and the part of bearing portion contact with each other being a balanced fulcrum.

With the above-described structures, it is possible to enhance impact resistance and to enable easy setting of the pressing load against the recording medium with high precision. Therefore, reliability of the magnetic recording apparatus is improved. In addition, the above-mentioned projection that bulges from the load beam or the support arm increases a limited area on the load beam or the support arm, so that plastic deformation caused by an impact can be prevented.

What is claimed is:

1. A magnetic head apparatus comprising:
a load beam to which a slider is attached;
an elastically deformable portion that is provided on said load beam so that a floating structure that allows said load beam to swing is formed about said elastically deformable portion; and
a projection bulging from said load beam that is adapted to function as a load generating portion;
wherein a pressing load of said slider against a recording medium is set by a pressure applied to a top portion of said projection.

2. A magnetic head apparatus comprising:
a load beam to which a slider is attached;
an elastically deformable portion that is provided on said load beam so that a floating structure that allows said load beam to swing is formed about said elastically deformable portion; and
a projection bulging from said load beam that is adapted to function as a load generating portion;
wherein said projection is adapted to coincide with a balanced fulcrum about said load beam; and
a pressing load of said slider against a recording medium is set by a pressure applied to a top portion of said projection.

3. A magnetic head apparatus comprising:
a base plate adapted to be attached to a head arm;
a load beam that extends from the base plate;
a slider attached to said load beam;
an elastically deformable portion that is provided between said base palate and said load beam so that a floating structure that allows said load beam to swing is formed about said elastically deformable portion;
a projection bulging from said load beam that is adapted to function as a load generating portion;
wherein said projection is adapted to coincide with a balanced fulcrum about said load beam;
a pressing load is applied to a surface of a recording medium via said slider; and
the pressing load of said slider against the recording medium is set by a pressure applied to a top portion of said projection.

4. A magnetic head apparatus according to any one of claims 1 to 3, wherein said projection bulging from said load beam sets such a limited area around said projection with which when an impact within a predetermined value range is applied to said load beam in a vertical direction, deformation of said load beam would remain within elastic deformation range.

5. A magnetic head supporting mechanism comprising:
a magnetic head apparatus including a base plate and a load beam extending from the base plate;
a head arm attached to said base plate;
a slider attached to said load beam;
an elastically deformable portion provided between said base plate and said load beam, said elastically deformable portion being flexible so that a floating structure that allows said load beam to swing is formed about said elastically deformable portion; and
a projection bulging from said load beam that is adapted to function as a load generating portion;
wherein a pressing load is applied to a surface of a recording medium via said slider; and
the pressing load of said slider against the recording medium is set by a pressure applied to a top portion of said projection.

6. A magnetic head supporting mechanism comprising:
a magnetic head apparatus including a base plate and a load beam extending from the base plate;
a head arm attached to said base plate;
a slider attached to said load beam;
an elastically deformable portion provided between said base plate and said load beam, said elastically deformable portion being flexible so that a floating structure that allows said load beam to swing is formed about said elastically deformable portion; and
a projection bulging from said load beam that is adapted to function as a load generating portion;
wherein said projection is adapted to coincide with a balanced fulcrum about said load beam;
a pressing load is applied to a surface of a recording medium via said slider; and
the pressing load of said slider against the recording medium is set by a pressure applied to a top portion of said projection.

7. A magnetic head supporting mechanism according to claim 5 or 6, wherein said projection bulging from said load beam sets such a limited area around said projection with which when an impact within a predetermined value range is applied to said load beam in a vertical direction, deformation of said load beam would remain within elastic deformation range.

8. A magnetic head supporting mechanism comprising:
a support arm swingable in a radial direction of a recording medium and in a direction perpendicular to a recording surface of the recording medium with a bearing portion being a pivot;
a head attached to a lower surface of said support arm at one end of said support arm;
elastic means provided on said support arm for imparting a biasing force in the direction toward said recording medium, to said support arm; and
a projection bulging from said support arm adapted to be in point contact with a part of bearing portion;
wherein said support arm is adapted to be swingable in the direction perpendicular to the recording surface, with a point at which a top portion of said projection and said part of bearing portion are in contact with each other being a balanced fulcrum.

9. A head supporting mechanism according to claim 8, wherein said projection bulging from said arm sets such a limited area around said projection with which when an impact within a predetermined value range is applied to said support arm in a vertical direction, deformation of a portion in the vicinity of said projection would remain within elastic deformation range.

10. A magnetic recording apparatus equipped with a magnetic head apparatus according to any one of claims 1 to 3.

11. A magnetic recording apparatus equipped with a magnetic head supporting mechanism according to any one of claims 5, 6 and 8.
